(19) United States
(12) Patent Application Publication
(10) Pub. No.: US 2013/0240697 A1
(43) Pub. Date: Sep. 19, 2013

(54) Bracket and hook assembly

(71) Applicant: Chrysanthe Marie Rutigliano, Ridgefield, CT (US)

(72) Inventor: Chrysanthe Marie Rutigliano, Ridgefield, CT (US)

(21) Appl. No.: 13/385,966

(22) Filed: Mar. 19, 2012

(51) Int. Cl. F16B 45/00; F16M 13/02

(52) U.S. Cl. 248/227.1

(57) ABSTRACT

An assembly 1 for temporarily mounting articles to a wall has a first section 2, a second section 3, a third section 4, and a hook section 5. By using threaded pin and slot type connections and locking nuts, one or more of the sections may be adjustably locked to the other. This facilitates adjustment of the width that may be accommodated of a wall or structure.

### RELATED APPLICATIONS

None.

### TECHNICAL FIELD

The present invention relates to hardware components for mounting and hanging articles and, more particularly, to bracket and hook assemblies for mounting and hanging articles to a vertical wall, fence or similar structure.

### BACKGROUND OF THE INVENTION

Various bracket and hook assemblies exist in many different configurations and sizes. Certain of such assemblies require permanent attachment to a structure from which the assembly will mount or suspend an article. Others are adapted to mount or suspend an article from a structure but are incapable of securely and precisely fitting the size of a wall or structure so as to prevent tilting, wobbling, or falling off. Other types of bracket and hook assemblies are large, cumbersome, expensive, and visibly prominent.

### OBECTS OF THE PRESENT INVENTION

It is desirable to provide a bracket and hook assembly that does not required permanent attachment to a structure, that does provide a secure and precise fit to the structure, that uses space and materials efficiently, that is inexpensive to manufacture, and that is visibly obscure due to its low profile and small size.

These and other objects are described herein.

### SUMMARY OF THE PRESENT INVENTION

An assembly for mounting and securing articles to a vertical structure, such as a wall, has a first vertical section for contacting a first side of the wall, a second vertical section for contacting a second side of the wall, and horizontal section connecting the first and second vertical sections and adapted to rest on top of the vertical structure, and a hook or other suitable implement attached to the second vertical section at an end opposite the horizontal section for attaching and securing an article or articles. One or more of the sections and hook may be secured to an adjacent section permanently or, preferably, non-permanently so that the assembly may be easily shipped and stored in a disassembled, or partially disassembled, state. The individual sections may be provided with means to select one of a plurality of specific points of attachment to each other to facilitate adjustment of size to accommodate varying sizes of vertical structure or wall to be attached to.

The present invention assembly has many possible uses including, but not limited to, hanging ornamental articles such as Christmas or holiday garland, lights, wreaths, bows, and other decorations on a stone wall or a fence.

### BRIEF DESCRIPTION OF THE DRAWINGS

FIG. 1 is an isometric view of a pair of assemblies according to the present invention mounted on a wall.

FIG. 2 is an isometric view of a first embodiment of the present invention assembly.

FIG. 3 is an exploded,isometric view of a first embodiment of the present invention assembly.

FIG. 4 is an isometric view of a second embodiment of the present invention assembly.

FIG. 5 is an exploded, isometric view of a second embodiment of the present invention assembly.

### DESCRIPTION OF THE PREFERRED EMBODIMENTS

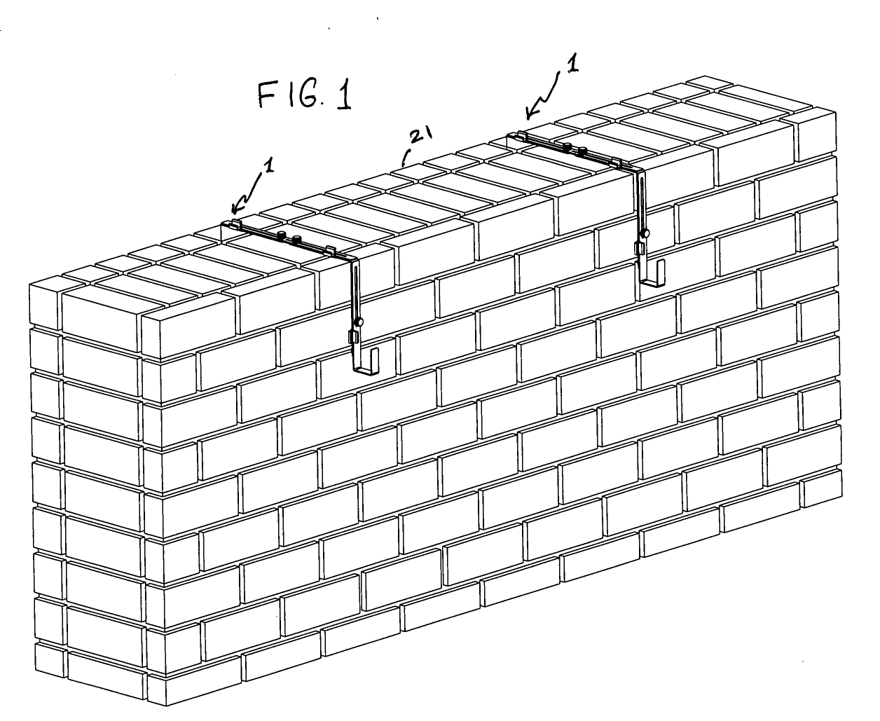

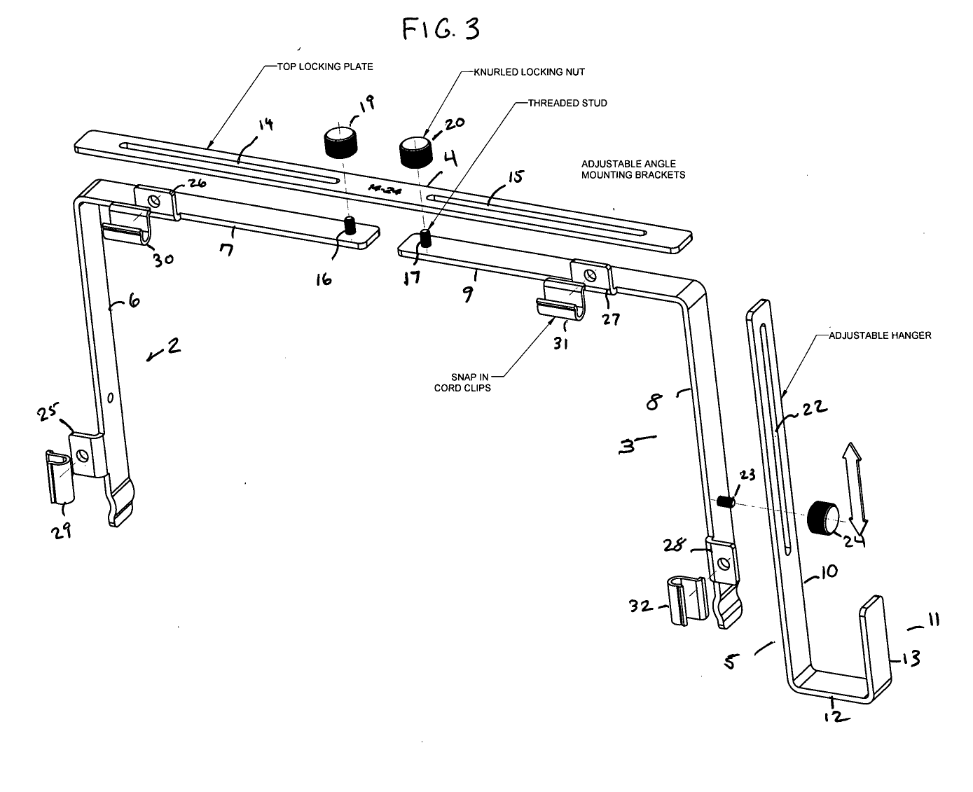

Referring to FIGS. 1-3, an assembly 1 of the present invention comprises a first section 2, a second section 3, a third section 4, and a hook section 5. The first section 2 has a vertical component 6 and a horizontal component 7. The second section 3 has a vertical component 8 and a horizontal component 9. The third section 4 is a straight member that, when assembled to the first and section sections 2, 3 is arranged horizontally. The hook section 5 has a vertical component 10 and a hook end 11, the hook end 11 having a horizontal section 12 and vertical section 13.

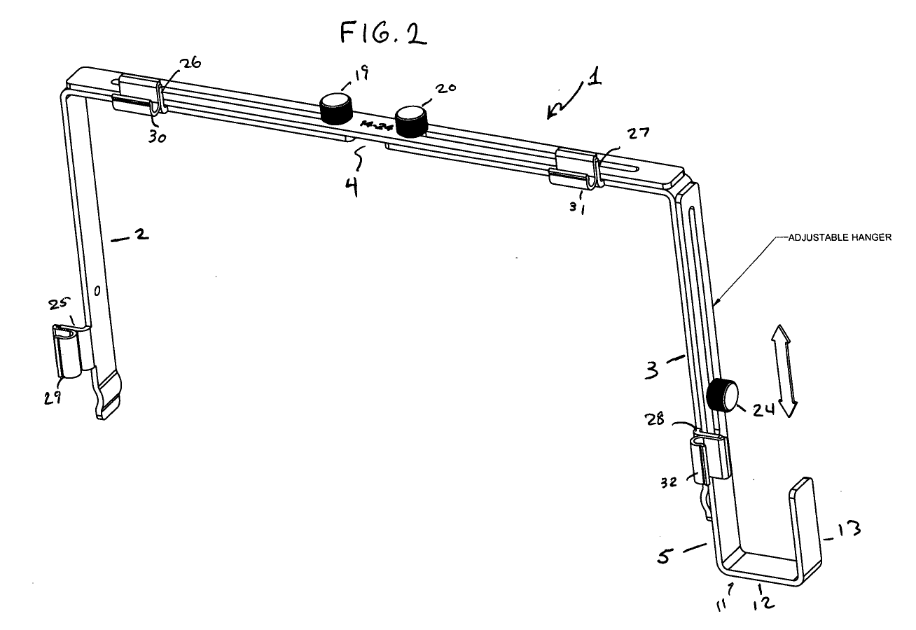

As shown in FIGS. 1 and 2, the third section 4 has a first slot 14 and a second slot 15. Each of the slots 14, 15 is engaged by a respective threaded stud 16, 17, each corresponding to one of the first section 2 and the second section 3. The studs 16, 17 are located on the horizontal components 7, 9.

Each stud 16, 17 passes through the respective slot 14, 15 and a respective locking nut 19, 20 is engaged on and tightened down on the respective stud 16, 17 to fix the relative orientations of the first section 2, second section 3 and third section 4 with respect to each other. This facilitates adjustment of the width that may be accommodated of a wall or structure, such as wall 21 shown in FIG. 1, when the assembly 1 is placed thereon.

The hook section's vertical component 10 has a slot 22. The vertical component 9 of the second section 3 has a stud 23 that is received through the slot 22, and a locking nut 24 is engaged on the stud 23 to lock the hook section 5 relative to the second section 3 in a selectively adjustable position.

First and second tabs 25, 26 on the first section 2, and first and second tabs 27, 28 on the second section 3, are located on a common side in order to mount clips 29, 30, 31, 32 that are specifically adapted to retain a standard electrical cord (not shown) in a press-fit manner. This is particularly useful if the present invention assembly 1 is used to hang electrical lights or electrically powered articles on the hook section 5 when the assembly 1 is mounted to a wall 21.

During use the assembly 1 can be adjusted due to the slots 14, 15 in the third section 4 to accommodate a variety of widths of a wall 21. A plurality of such assemblies as the present invention assembly 1 can be placed in series along a wall or structure to hand lights, garland, articles and ornaments. The slot 22 in the hook section 5 makes it possible to adjust the height from which an article or the like may be hung. While the preferred embodiment discloses a hook section 5 having a hook-shaped implement, it is contemplated that the hook section may have any of a variety of configurations suitable to hang, mount or suspend articles. It is further contemplated that the hook section may be substituted with a clamp, threaded fastener, magnet, hook-and-loop fastener, or other known attachment means.

The assembly 1 may be made of any one or combination of suitable structural materials including, but not limited to, metallic materials and plastic materials.

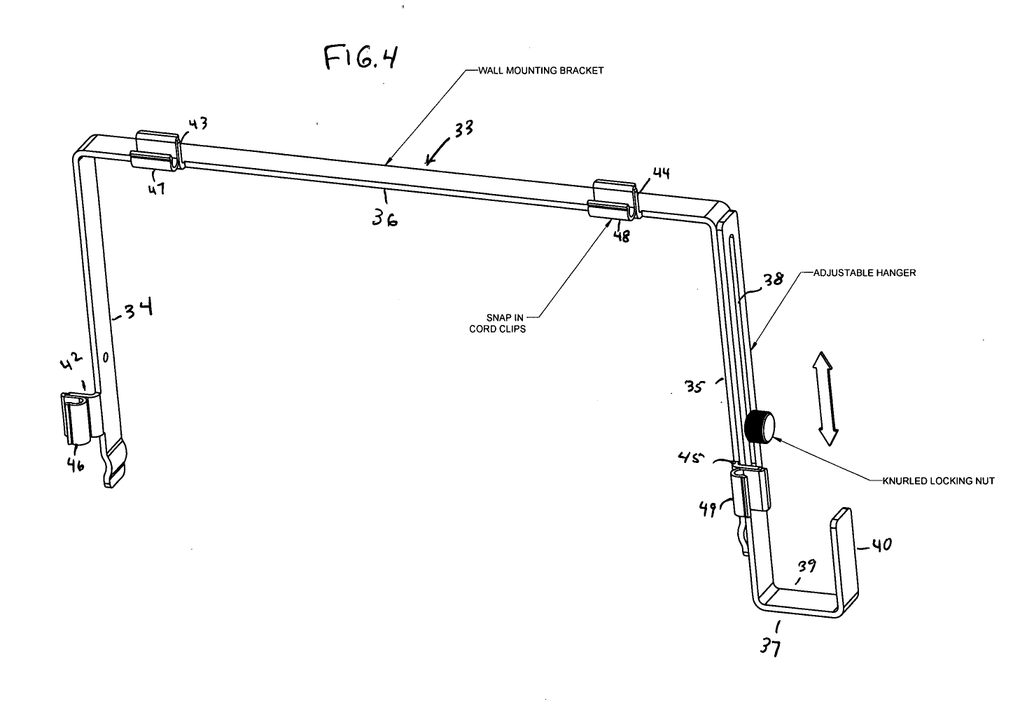

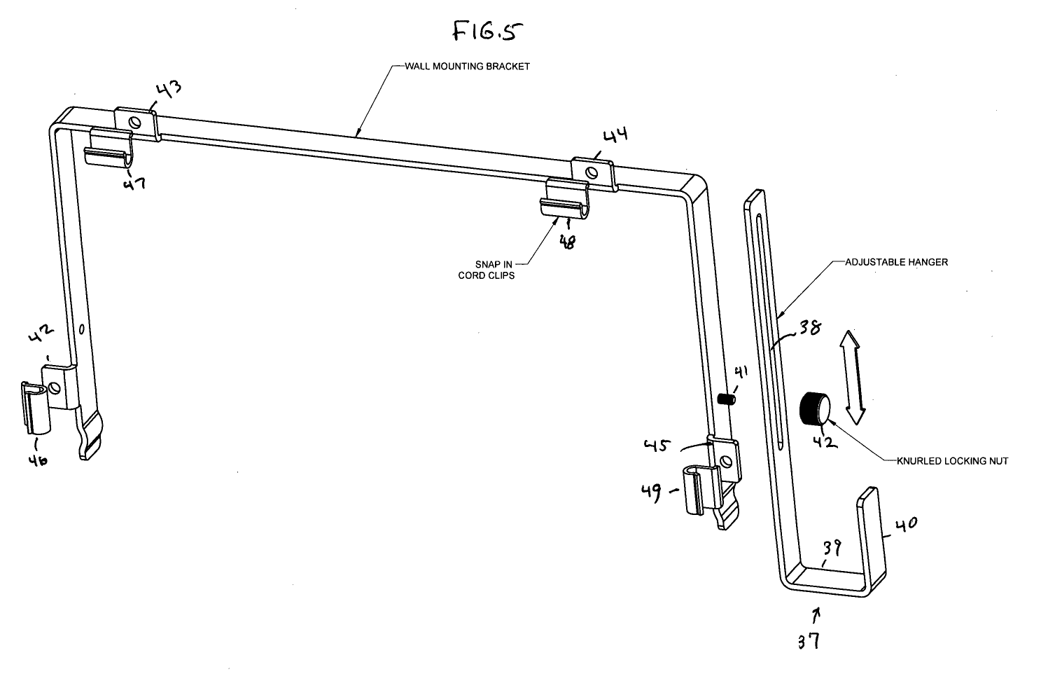

A second preferred embodiment of the present invention is shown in FIGS. 4 and 5. A main body 33 has a first vertical component 34, a second vertical component 35, and a horizontal component 36 that connects the first and second vertical components. These three components are permanently attached and not adjustable. A hook section 37 has a slot 38, a horizontal component 39, and a vertical component 40. The slot 38 is passed through by a threaded stud 41, and a locking nut 42 engages the stud 41 to adjustably secure the hook section 37 to the main body 33. A plurality of tabs 42, 43, 44 and 45 accommodate corresponding clips 46, 47, 48 and 49 to secure an electrical cord (not shown).

While the preferred embodiments of the present invention have been shown and described herein, various modifications may be made without departing from the scope of the invention.

What is claimed is:

1. An assembly comprising
a first vertical component;
a second vertical component;
a horizontal component positioned between and connected to said first and second vertical components; and
a hook component adjustable mounted to said second vertical component so that it may adjustably mounted in a vertical position with respect to said second vertical component, said hook component having a generally hook-shaped end.

2. An assembly according to claim 1, further comprising
a threaded stud extending from said second vertical component;
a slot in said hook component that receives said stud therethrough; and
a locking nut that is removably mounted to said stud to secure said hook component relative to said second vertical component.

3. An assembly according to claim 1, wherein
said first vertical component and said second vertical component are each adjustably mounted to said horizontal component such that said first vertical component and said second vertical component may be adjustably spaced apart from each other.

4. An assembly according to claim 1, further comprising
a plurality of clips attached to said assembly, said clips each being adapted to receive and secure a cord in a press-fit manner.

5. An assembly according to claim 3, wherein
said first vertical component has a horizontal part extending therefrom and a threaded pin extending vertically therefrom;
said second vertical component has a horizontal part extending therefrom and a threaded pin extending vertically therefrom;
said horizontal component has two slots, each one receiving one of said pins of said first vertical component and said second vertical component; and
a pair of threaded locking nuts each correspond to one of said pins to engage the same and lock said horizontal component adjustably with respect to said first and second vertical components.
